(19) United States
(12) Patent Application Publication
(10) Pub. No.: US 2025/0173520 A1
(43) Pub. Date: May 29, 2025

(54) SYSTEMS AND METHODS FOR ASSESSING PREDICTIVE WEIGHTS IN NATURAL LANGUAGE PROCESSING

(71) Applicant: KONINKLIJKE PHILIPS N.V., EINDHOVEN (NL)

(72) Inventors: ASHEQUL QADIR, MELROSE, MA (US); ANKUR SUKHALAL PADIA, CAMBRIDGE, MA (US); KATHY MI YOUNG LEE, WESTFORD, MA (US); MLADEN MILOSEVIC, STONEHAM, MA (US); VIVEK VARMA DATLA, ASHLAND, MA (US)

(21) Appl. No.: 18/843,357

(22) PCT Filed: May 1, 2023
(86) PCT No.: PCT/EP2023/055062

§ 371 Date: Sep. 3, 2024

Related U.S. Application Data
(60) Provisional application No. 63/317,861, filed on Mar. 8, 2022.

(51) Int. Cl. G06F 40/40; G06N 20/00

(52) U.S. Cl. CPC G06F 40/40; G06N 20/00

(57) ABSTRACT

The present disclosure relates to a method for evaluating predictive weights of individual sentences in a document and visually representing the sentences based on the weights. The document is from a document repository and variants of the document are generated by excluding certain number of sentences from the document. By use of a trained prediction model that provides a confidence score for each prediction, the document and the variants are predicted, and respective confidence scores are determined. A weight of a sentence for all sentences in the document is determined by use of the confidence scores respective to the predictions based on the document and each of the variants. The sentences in the document are presented in a manner visually differentiated by respective weights of the sentences in the document.

### FIELD OF THE DISCLOSURE

The present disclosure relates to predictive analytics based on machine learning and text classification in natural language processing, and more specifically to computer-implemented systems and methods for assessing predictive weights of sentences in a document of interest.

### BACKGROUND

Conventional artificial intelligence (AI) applications often utilize machine learning algorithms or machine learning models that generate an outcome without any explanation why the outcome had been generated. As the areas of AI application widen and needs to know why certain outcomes are generated by conventional AI, explainable AI (XAI) has emerged as an area of AI technology that provide explanations to outcomes to move away from conventional black-box AI applications providing only outcomes without reasons. When AI applications are applied in application areas with “big data” (which refers to a field that treats ways to analyze, systematically extract information from, or otherwise deal with data sets that are too large or complex to be dealt with by traditional data-processing application software) in which misinterpretation on the big data would be costly in terms of time and resources used to interpret the big data, significance in consequences, or accountability, such AI applications are often used as a recommendation tool for human experts performing application tasks. Accordingly, interests and needs on providing explanations on reasons behind outcomes of AI applications are in growth.

### SUMMARY OF THE DISCLOSURE

In accordance with aspects of the present disclosure, the computer implemented method includes: obtaining, by one or more processors, a document from a document repository, the document including a plurality of sentences; generating, by the one or more processors, a plurality of variants of the document by excluding a predefined number of sentences from the document; making, by the one or more processors, predictions based on the document and each of the variants, respectively, by use of a trained prediction model that provides a confidence score for each of the predictions, the confidence score indicating a probability of a prediction based on an input being correct; determining, by the one or more processors, by use of the confidence scores respective to the predictions based on the document and each of the variants, a weight of a sentence for all sentences in the document, the weight of the sentence indicating an average contribution of the sentence to the confidence score of a prediction based on the document; and presenting, by the one or more processors, via a user interface and a video output device, the document with varying degrees of visual effects determined based on respective weights of the sentences in the document, the varying degrees of visual effects are preconfigured for the document.

In an aspect, the method also includes: preparing the trained prediction model by selecting a prediction model based on performance of the prediction model, by training the prediction model with a labeled dataset in an application task compatible with an application task of the document repository, and by validating the performance of the prediction model to be greater than a confidence threshold by use of a test dataset amongst the labeled dataset that had not been used in the training.

In an aspect, the method also includes: tuning the number of the variants of the document, denoted as N, and the predefined number of sentences to exclude from the document to make each of the variants, denoted as m, by use of a grid search approach with respect to a combination of N and m for all available combinations based on a validation dataset amongst a labeled dataset that had not been used in training the trained prediction model to thereby improve respective accuracies of the weight of the sentence for all the sentences in the document.

In an aspect, the method also includes: selecting, amongst the plurality of variants, each variant that does not include a current sentence; computing a difference between a confidence scores of a prediction based on a first variant of each variant from the selecting and the confidence score of the prediction based on the document; iterating the step of computing the difference for each variant from the selecting against the document; adding the respective differences from the computing; dividing a result from the adding by the number of the variants of the document from the making; and assigning a result from the dividing as a weight of the current sentence.

In an aspect, the method also includes: iterating, for all sentences in the document, the steps of: selecting, amongst the plurality of variants, each variant that does not include a current sentence; computing respective differences between respective confidence scores of predictions based on each variant from the selecting and the confidence score of the prediction based on the document; adding the respective differences from the computing; dividing a result from the adding by the number of the variants of the document from the making; and assigning a result from the dividing as a weight of the current sentence.

In an aspect, the method also includes: concurrently performing, for all sentences in the document, the steps of: selecting, amongst the plurality of variants, each variant that does not include a current sentence; computing respective differences between respective confidence scores of predictions based on each variant from the selecting and the confidence score of the prediction based on the document; adding the respective differences from the computing; dividing a result from the adding by the number of the variants of the document from the making; and assigning a result from the dividing as a weight of the current sentence.

In an aspect, the method also includes: configuring the varying degrees of the visual effects for the document based on the application task, the varying degrees including two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

In accordance with aspects of the present disclosure, the system includes: a memory, one or more processors in communication with the memory, and program instructions executable by the one or more processors via the memory configured to: obtain a document from a document repository, the document including a plurality of sentences; generate a plurality of variants of the document by excluding a predefined number of sentences from the document; make predictions based on the document and each of the variants, respectively, by use of a trained prediction model that provides a confidence score for each of the predictions, the confidence score indicating a probability of a prediction based on an input being correct; determine, by use of the confidence scores respective to the predictions based on the document and each of the variants, a weight of a sentence for all sentences in the document, the weight of the sentence indicating an average contribution of the sentence to the confidence score of a prediction based on the document; and present via a user interface and a video output device, the document with varying degrees of visual effects determined based on respective weights of the sentences in the document, the varying degrees of visual effects are preconfigured for the document.

In one aspect, the system is also configured to: prepare the trained prediction model by selecting a prediction model based on performance of the prediction model, by training the prediction model with a labeled dataset in an application task compatible with an application task of the document repository, and by validating the performance of the prediction model to be greater than a confidence threshold by use of a test dataset amongst the labeled dataset that had not been used for training.

In one aspect, the system is also configured to: tune the number of the variants of the document, denoted as N, and the predefined number of sentences to exclude from the document to make each of the variants, denoted as m, by use of a grid search approach with respect to a combination of N and m for all available combinations based on a validation dataset amongst a labeled dataset that had not been used in training the trained prediction model to thereby improve respective accuracies of the weight of the sentence for all the sentences in the document.

In one aspect, the system is also configured to: select, amongst the plurality of variants, each variant that does not include a current sentence; compute a difference between a confidence scores of a prediction based on a first variant of each variant that has been previously selected and the confidence score of the prediction based on the document; iterate the instruction to compute the difference for each variant that has been previously selected against the document; add the respective differences that has been previously computed; divide a result from adding the respective differences by the number of the variants of the document made; and assign a result dividing a sum of the respective differences by the number of the variants of the document as a weight of the current sentence.

In one aspect, the system is also configured to: set values for the varying degrees of the visual effects for the document based on the application task, the varying degrees including two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

In accordance with aspects of the present disclosure, the computer program product includes data representing program instructions executable by one or more processors via a memory configured to: obtain a document from a document repository, the document including a plurality of sentences; generate a plurality of variants of the document by excluding a predefined number of sentences from the document; make predictions based on the document and each of the variants, respectively, by use of a trained prediction model that provides a confidence score for each of the predictions, the confidence score indicating a probability of a prediction based on an input being correct; determine, by use of the confidence scores respective to the predictions based on the document and each of the variants, a weight of a sentence for all sentences in the document, the weight of the sentence indicating an average contribution of the sentence to the confidence score of a prediction based on the document; and present via a user interface and a video output device, the document with varying degrees of visual effects determined based on respective weights of the sentences in the document, the varying degrees of visual effects are preconfigured for the document.

In one aspect, the computer program product is also configured to: select, amongst the plurality of variants, each variant that does not include a current sentence; compute a difference between a confidence scores of a prediction based on a first variant of each variant that has been previously selected and the confidence score of the prediction based on the document; iterate the instruction to compute the difference for each variant that has been previously selected against the document; add the respective differences that has been previously computed; divide a result from adding the respective differences by the number of the variants of the document made; and assign a result dividing a sum of the respective differences by the number of the variants of the document as a weight of the current sentence.

In one aspect, the computer program product is also configured to: set values for the varying degrees of the visual effects for the document based on the application task, the varying degrees including two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

It will be appreciated by those skilled in the art that two or more of the above-mentioned embodiments, implementations, and/or optional aspects of the present disclosure may be combined in any way deemed useful. Modifications and variations of any system and/or any computer readable medium, which correspond to the described modifications and variations of a corresponding computer-implemented method, can be carried out by a person skilled in the art on the basis of the present description.

### BRIEF DESCRIPTION OF THE DRAWINGS

These and other aspects of the present disclosure will be apparent from and elucidated further with reference to the embodiments described by way of example in the following description and with reference to the accompanying drawings, in which:

FIG. 1 shows functional components of a system evaluating predictive weights of sentences in documents;

FIG. 2 shows a computer-implemented method of the sentence evaluation system of FIG. 1;

FIG. 3 shows a detailed example of how to weight sentences in block 240 of FIG. 2;

FIG. 4 shows respective examples of the document and the sentence weight marked document as produced by the sentence evaluation system; and

FIG. 5 shows a computer-readable medium comprising data.

It should be noted that the figures are purely diagrammatic and not drawn to scale. In the figures, elements which correspond to elements already described may have the same reference numerals.

### DETAILED DESCRIPTION OF EMBODIMENTS

The present disclosure is directed to systems and methods that provide a more meaningful unit than words or phrases in documents assessed for a predictive significance in technology of natural language processing and text classification for explainable AI. The present disclosure also provides techniques to explain predictions made by machine learning models without any restriction on types of machine learning model that can be utilized, which would be advantageous to conventional explainable AI that is often limited to a specific machine learning model. The present disclosure appreciably recognizes that sentences with more predictive significances can be identified in certain application areas such as medical diagnostics, quality assurance, or regulatory compliance. The systems and methods of the present disclosure improve readability of documents by use of enhanced visual representation of all sentences in a document corresponding to respective predictive significances of the sentences.

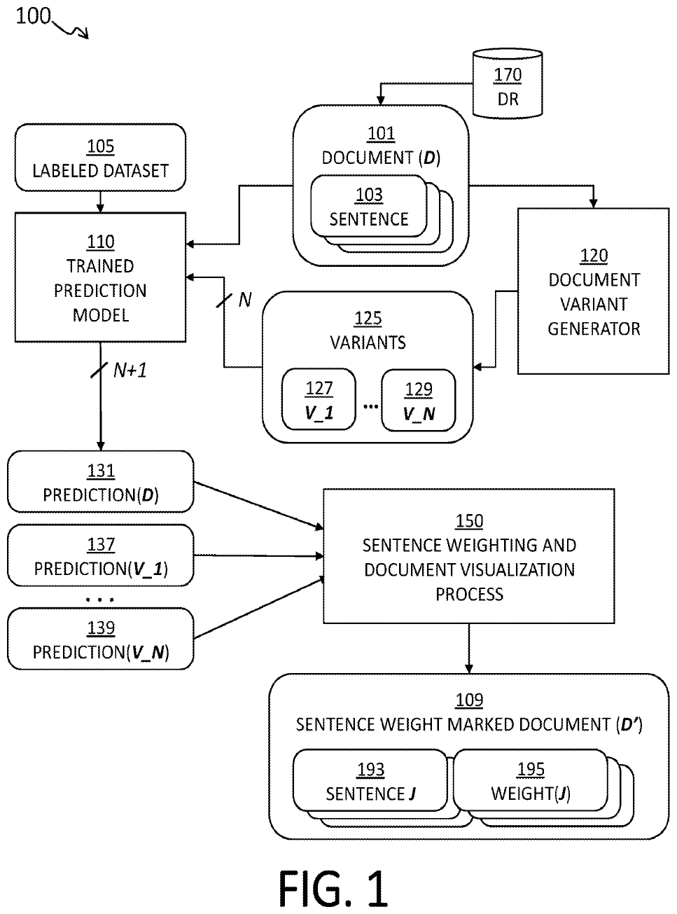

FIG. 1 shows functional components of a system evaluating predictive weights of sentences in documents.

The system evaluating predictive weights of all sentences in documents is noted as a sentence evaluation system 100 in the present disclosure. Components of the sentence evaluation system 100 can run on respective servers, cloud computing nodes, or any other computing platforms that can be geographically distributed but operatively coupled via digital communication network and other communication interface.

The sentence evaluation system 100 includes a trained prediction model 110, a document variant generator 120, a sentence weighting and document visualization process 150, and a document repository (DR) 170. The sentence evaluation system 100 also includes a user/data interface and a video output device for presentation of output from the sentence weighting and document visualization process 150.

The trained prediction model 110 utilizes a labeled dataset 105, indicating a dataset having respective data instance labeled manually by human experts or automatically by text classification mechanism assisted by natural language processing (NLP) and other cognitive analytics (CA) mechanisms in artificial intelligence (AI) technology. The labeled dataset 105 is on an application task that is compatible with the application task of the document 101 and the DR 170.

A document 101, denoted also as D in this disclosure, includes a plurality of sentences 103. The document is stored in the DR 170 for an application task in which a human expert will make a final decision but can be greatly benefited from recommendations and explanations made by predictive models, with respect to accuracy and reliability. The application task indicates a field of use for which the predictions by machine learning models are utilized. Examples of the application task include, but are not limited to, quality and regulatory (Q&R) compliance investigations over issues on products, predictive diagnosis to support clinical decisions.

The document variant generator 120 produces variants 125 of the document 101 as an input. The variants 125 collectively indicate N number of variants of the document 101 including variant V_1127 through variant V_N 129, where N denotes a positive integer used to identify the number of the variants 125 generated from the document 101. Each of the variants includes a same (s-m) number of sentences selected from the document 101, where s indicates a positive integer used to indicate the number of sentences in the document 101, and m indicates a positive integer used to identify the number of sentences excluded from D 101 for each of the variants 125.

The trained prediction model 110 generates individual predictions based on D 101 and V_1 127 through V_N 129, denoted as Prediction(D) 131, Prediction(V_1) 137 through Prediction(V_N) 139, respectively. Each of the predictions Prediction(D) 131, Prediction(V_1) 137 through Prediction(V_N) 139 includes a predictive proposition and a probability corresponding to the predictive proposition when an input is selected from D 101 and V_1 127 through V_N 129, respectively. In this disclosure, the term probability refers to a likelihood of a predictive outcome made by the trained prediction model 110 based on a specific input X, denoted as P(X) would be correct, in a range between 0.0 and 1.0, accordingly, a greater number represents more reliability of the predictive proposition made by the trained prediction model 110. The probability P(X) can also be interchangeably used with a confidence score, a confidence, or an accuracy, in this disclosure. For the sentence evaluation system 100, Prediction(X) indicates a prediction by the trained prediction model 110 based on input X, as shown in Prediction(D) 131, Prediction(V_1) 137 through Prediction(V_N) 139, indicating predictions based on inputs of D 101 and V_1 127 through V_N 129, respectively. Prediction(X) includes a predictive proposition, including a class label or any other type of predictive outcome, and a probability P(X) corresponding to the predictive proposition made by the trained prediction model 110. Prediction(X) can be represented by the probability P(X) in the sentence evaluation system 100 as the predictive proposition is not utilized in determining predictive weights of the sentences.

Prediction(D) 131, represented by a probability P(D) for the predictive proposition made by the trained prediction model 110 based on input D 101, is to be reasonably strong, for example, greater than or equal to 0.85.

The sentence weighting and document visualization process 150 of the sentence evaluation system 100 takes Prediction(D) 131, Prediction(V_1) 137 through Prediction(V_N) 139 as inputs and produces a sentence weight marked document 109, denoted also as D′ in this disclosure, by assessing respective predictive strengths of each of the sentences 103 and visualizing the respective predictive strengths of each of the sentences 103 in the document 101.

D′ 109 includes the sentences 103 same as the document 101, represented by Sentence J 193, and the predictive strengths respectively corresponding to the sentences 103, represented by Weight(J) 195, where J indicates a positive integer used to identify each of the sentences 103 in the document 101. In this disclosure, Weight(J) 195 can be also referred to as, for example, a predictive strength, a weight, a predictive weight, a predictive power of Sentence J 193, to indicate a level of contribution by Sentence J 193 to the confidence score of the predictive proposition based on the document 101, denoted as P(D) as noted above.

The sentence evaluation system 100 explains why certain predictions made upon a given input document have a certain level of confidence scores by quantifying predictive weights of individual sentences of the input document, in contrast with conventional text classifications by machine learning that are often done by word labeling or by keyword appearance approaches. Further, the sentence evaluation system 100 of the present disclosure offers such explanation to the predictions by using any trained prediction model without limitations to types of machine learning model only if the prediction model is trained to meet a certain level of confidence score. In contrast, to provide explainable predictions in a conventional way, particular types of prediction model such as a decision tree or attention mechanism should have been used regardless of the inherent performance of the prediction model.

Explainable AI (XAI) technology is rapidly growing because predictions based on machine learning are more and more widely used, and accordingly, the need to know why such predictions made are growing. Knowing the bases for the predictions by machine learning models would be particularly beneficial in many real-world application tasks that utilize machine learning to learn from big data and to assist with preliminary decisions on issues represented in data, but human experts would need to review the predictions and finally decide a course of action on the issues.

For example, when medical practitioners diagnose patients, although a diagnostics machine learning model can be used to analyze patent data, clinical notes, and related medical records, a doctor would ultimately diagnose the patients. Accordingly, a diagnostic recommendation predicted by the diagnostics machine learning model with explanations and reasons for the prediction would be substantially more useful to the doctor than a prediction without any basis to why such prediction had been made. Further, the benefit to the doctor would be even greater when the diagnostic prediction is presented in a manner which the explanations and reasons would be easily recognized by the doctor as in a highlighted document.

For another example, in areas of quality and regulatory (Q&R) applications, predictions by machine learning on investigation codes made to find out issues with a certain product based on incident description would be much more useful to investigators when certain sentences of the incident description such as service notes and case notes are specified as reasons for the predictions than without any grounds for the predictions. Similarly, predictions by machine learning made to spot any compliance issues of products with respect to certain regulations can contribute to identifying any compliance issues if the prediction is presented with why such conclusion had been reached by visually identifying a basis of the prediction in input documents describing the product and/or the regulations. Also in the area of quality assurance, product reviews can be analyzed by a machine learning model making predictions on how a product is accepted, and certain sentences in the product reviews can be assessed as carrying more weights than other sentences and can be used to estimate customer satisfaction on similar products by analyzing a different set of product reviews for the similar products.

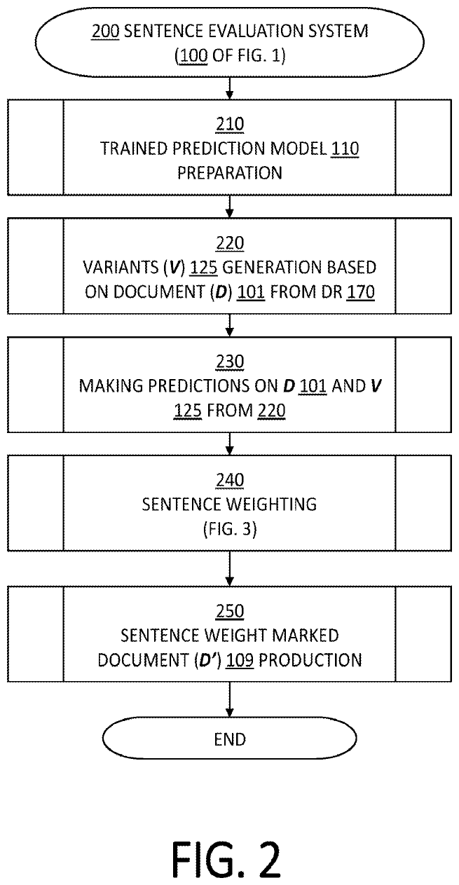

FIG. 2 shows a flowchart 200 describing a computer-implemented method performed by the sentence evaluation system 100 of FIG. 1.

Blocks 210 through 250 in the flowchart 200 respectively represent high-level tasks performed by the sentence evaluation system 100. Accordingly, each block in the flowchart 200 can include any number of operations that are not shown but logically and inherently required to achieve a high-level task corresponding to each block. Any number of blocks in the flowchart 200 can be performed concurrently if there is no logical dependency such as input/output or prerequisites amongst the blocks.

In block 210, the sentence evaluation system 100 prepares the trained prediction model 110 by use of the labeled dataset 105 for an application task. The trained prediction model 110 will generate a class prediction and a confidence score corresponding to the class prediction for an input data. The trained prediction model 110 shall be trained to the extent that the confidence scores of class predictions, or classification, made by the trained prediction model 110 would be reasonably high so that individual sentence weights can be measured based thereon, when the class predictions were based on a test dataset from the application task same as the labeled dataset 105 that had not been used for training. Then, the sentence evaluation system 100 proceeds with block 220.

In certain embodiments, the sentence evaluation system 100 in block 210 can prepare the labeled dataset 105 by labelling raw dataset from the application task by use of a data labelling tool. The DR 170 can correspond to the application task and the raw dataset could be obtained from the DR 170 along with the document 101. The data labelling tool would be any other classification machine learning model in use, and a label or a class describes content of a data, pursuant to the application task and types of the data in the raw dataset. Accordingly, the labeled dataset 105 would train a machine learning prediction model more efficiently with improved accuracies with predictions made by the machine learning prediction model after being deployed. The labeled dataset 105 is large enough, for example, 1,000 or more instances, to train the machine learning prediction model until the confidence score of a class prediction by the trained prediction model 110 based on the test dataset would be greater than a confidence threshold, for example, 0.85, indicating that 85 percent of predictions made by the trained prediction model 110 would be trustworthy. The size of the labeled dataset 105, including a training dataset and a test dataset disjoint from the training dataset, a proportion of the training dataset and the test dataset dividing the labeled dataset 105, and the confidence threshold required for the trained prediction model 110, and other configuration parameters would be empirically determined based on requirements of the application task.

In certain embodiments, the sentence evaluation system 100 can begin with selecting any type of machine learning model to train for the trained prediction model 110, because the sentences 103 can be individually evaluated to explain the predictions, including Prediction(D) 131, Prediction(V_1) 137 through Prediction(V_N) 139, based only on the predictions without any explainable mechanism in the prediction model. It is noted that conventional XAI mechanism often has limitations on types of machine learning model and methods used to provide certain reasons for predictions as in decision trees or attention mechanism on neural networks, while the sentence evaluation system 100 can choose any type of machine learning model such as a support vector machine (SVM), a long-short term memory (LSTM) network, or a logistic regression (LR), which often outperform XAI methods and models, based solely on performance of the machine learning model.

In certain embodiments, the sentence evaluation system 100 offers explanations to the reasons that had not been previously available for predictions made by the trained prediction model 110 currently in use with strong class prediction performances, which is classical black-box AI model. Based on characteristics of the application task and needs to understand the reasons behind the class prediction performances, the sentence evaluation system 100 will improve understanding of the trained prediction model 110 to further enhance the utility of the trained prediction model 110.

In block 220, the sentence evaluation system 100 generates the variants 125 of the document 101 from the document repository 170 of the application task by randomly masking a preconfigured number of sentences from the document 101. Each variant of the variants 125 would correspond to a sentence map, indicating which sentence is present or missing from a specific variant. Then, the sentence evaluation system 100 proceeds with block 230.

In certain embodiments, the document variant generator 120 performs block 220 of the sentence evaluation system 100. The document variant generator 120 takes the document D 101 as an input and generates the variants 125 of the document 101 by randomly excluding m number of sentences from s number of sentences in the document 101, where s and m are positive integers, and m<s. In certain embodiments, the document variant generator 120 can be configured to select sentences to mask more evenly than the random selection based on a systemic selection based on combinations of sentences from the document 103 or based on the number of words in each sentence.

The greater the number of the variants 125, that is, N, the more accurate the sentence weights, represented by Weight(J) 195 for each sentence J 193, with increased computation cost. Similarly, the smaller the number of the sentences masked from the document 101, that is, m, the more precise the sentence weights, represented by Weight(J) 195 for each sentence J 193, with increased computation cost. Contrastingly, either one of or a combination of the smaller N and a greater m would result in sentence weights that are more noisy and less accurate than the sentence weights resulting from a greater number of variants with a smaller number of sentences masked in variants. The number of variants (N) and the number of masked sentences in each variant (m) are hyperparameters that cannot be tuned by training but affects the performance of the sentence evaluation system 100 that can be empirically configured.

In certain embodiments where individual sentence weight accuracy matters more than other application tasks, the sentence evaluation system 100 can determine the number of variants (N) and the number of masked sentences in each variant (m) based on tuning by a grid search approach examining each combination available by use of a small sized validation dataset, also set aside from the labeled dataset 105. In the same embodiments, the sentence evaluation system 100 divide the labeled dataset 105 into 80:10:10, by the respective number of data instances, to be used as a training dataset, a validation dataset, and a testing dataset, respectively.

In block 230, the sentence evaluation system 100, by use of the trained prediction model 110, makes class predictions of Prediction(D) 131, Prediction(V_1) 137 through Prediction(V_N) 139, on inputs of the document D 101 and the variants 125, including V_1 127 through V_N 129, respectively. As noted above, the trained prediction model 110 makes a class prediction and a confidence score corresponding to the class prediction based on an input, denoted as Prediction(input) for inputs of D 101, and V_1 127 through V_N 129. Then, the sentence evaluation system 100 proceeds with block 240.

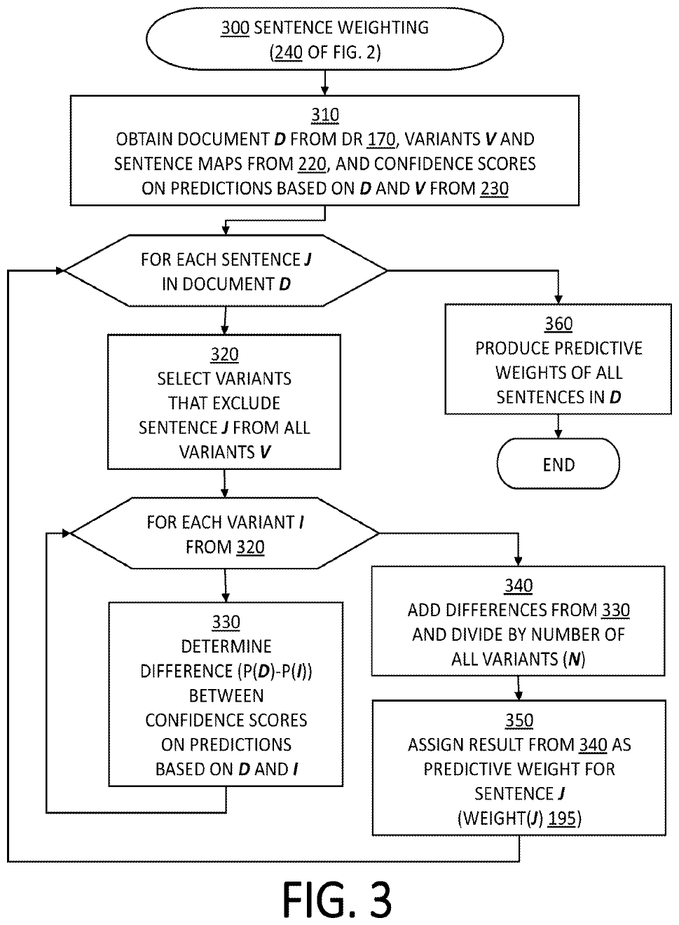

The sentence evaluation system 100 generates the predictions based on the inputs of the documents 101 and the variants, that is, Prediction (D) 131, Prediction(V_1) 137 through Prediction(V_N) 139, to compare a confidence score of a prediction based on each variant, Prediction(V_1) 137 through Prediction(V_N) 139, to a confidence score of the prediction based on the document, Prediction(D) 131. Based on the comparison, the sentence evaluation system 100 can determine any difference in the respective confidence scores as caused by excluded sentences in each of the variants 125 that are present in the document 101, which would be the basis of determining predictive weights of individual sentences in the document 101 as shown in block 240 and FIG. 3.

In certain embodiments, the sentence evaluation system 100 concurrently makes Prediction(D) 131, and Prediction(V_1) 137 through Prediction(V_N) 139, because the inputs of D 101, and V_1 127 through V_N 129 are independent after generation. In other embodiments, the sentence evaluation system 100 produces Prediction(D) 131, and Prediction(V_1) 137 through Prediction(V_N) 139, in any order or in any concurrency after the trained prediction model 110 is ready in block 210, to improve both computation efficiency and performance in processing time.

In block 240, the sentence evaluation system 100, by use of the sentence weighting and document visualization process 150, assesses predictive contributions of each sentence in the document 101 to the predictions made based on the input of the document 101 by use of the trained prediction model 110 by comparing confidence scores of Prediction(V_1) 137 through Prediction(V_N) 139 based on the variants 125 against the confidence score of Prediction (D) 131 based on the document D 101. The respective weights of the sentences 103 of the document 101 as calculated in block 240 would result in Weight(J) 195 for Sentence J 193, as shown in the sentence weight marked document (D′) 109 that is an output of the sentence evaluation system 100. Detailed operations of sentence weighting as performed in block 240 are presented in FIG. 3 and corresponding descriptions. Then, the sentence evaluation system 100 proceeds with block 250.

In block 250, the sentence evaluation system 100 produces the sentence weight marked document (D′) 109 that visualizes the sentences 103 based on respective weights for each sentence in the document D 101, Weight (J) 195 for Sentence J 193, as noted above. Then, the sentence evaluation system 100 terminates evaluation of the sentences 103 in the document D 101.

In certain embodiments, the sentence evaluation system 100 turns on or off each Sentence J 193 in the sentence weight marked document (D′) 109 based on comparing the value of Weight (J) 195 against a marking weight threshold value, for example, 0.5, such that any sentence having weight greater than 0.5 would be presented in D′ 109 but others will be masked. As in the number of the variants 125 (N) or the number of masked sentences in each of the variants 125, noted as m above, the marking weight threshold value can be empirically tuned based on a validation dataset relatively small to the training dataset. In other embodiments, the sentence evaluation system 100 would present each sentence of D′109 as a heat map based on two or more ranges of weight values by differentiating the sentences based on the respective weights with respect to a font size, a text effect, a font color, and a background color, and combinations thereof, where color indicates color effects including but not limited to color gradient, grayscale, marking or masking of the text of the sentences by setting the same or different colors, and where the text effect of the sentences including but not limited to underline, boldface, italic, shading, animation, and any available effect. The sentence evaluation system 100 present the sentence weight marked document D′ 109 with the aforementioned visual effects such that the sentences with more predictive weights in the document 101 to be more visible than sentences with less predictive weights.

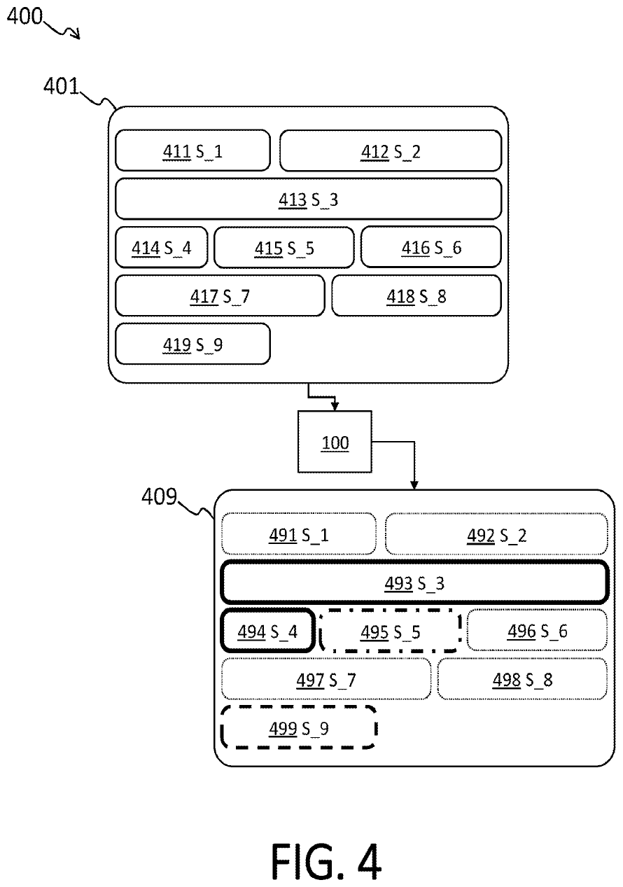

Regarding the output of the sentence evaluation system 100 as noted in block 250, FIG. 4 shows respective examples of the document D 101 and the sentence weight marked document D′ 109. A first document 401 is an example of the document D 101. The first document 401 includes 9 sentences denoted as S_1 411, S_2 412, S_3 413, S_4 414, S_5 415, S_6 416, S_7 417, S_8 418, and S_9 419, which are visually uniform within the first document 401. A second document 409 is an example of the sentence weight marked document D′ 109. The second document 409 includes 9 sentences same as the first document 401, denoted as S_1 491, S_2 492, S_3 493, S_4 494, S_5 495, S_6 496, S_7 497, S_8 498, and S_9 499, which are represented in four visually distinctive forms as represented by sentences S_1 491, S_2 492, S_6 496, S_7 497, and S_8 498 with no distinctive marking likely corresponding to the least weight value range, by sentences S_3 493 and S_4 494 with heavy boundaries likely corresponding to the highest weight value range, by the sentence S_5 495 and by the sentence S_9 499, corresponding to respective weight value ranges in the middle of a visualization scale.

FIG. 3 shows a detailed example of how to weight sentences in block 240 of FIG. 2.

In block 310, the sentence evaluation system 100 obtains the document D 101 from the document repository 170, the variants 125, denoted as V, and respective sentence maps corresponding to each of the variants 125 from block 220, and the confidence scores of the predictions based on D 101 and V 125 from block 230. Then, the sentence evaluation system 100 proceeds with block 320.

Blocks 320 through 350 of FIG. 3 are performed for each sentence, denoted as Sentence J 193, or J when used as a parameter, in the document D 101, to calculate an individual sentence weight, denoted as Weight(J) 195. The sentence evaluation system 100 proceeds with block 360 after blocks 320 through 350, as a unit, are performed for all sentences in the document D 101. A unit of blocks 320 through 350 for each sentence in the document 101 can be performed concurrently for all sentences in the document 101, with s number of execution threads, where computation resources are sufficient. Or the sentence evaluation system 100 may process each sentence in the document 101 sequentially one by one.

In block 320, the sentence evaluation system 100 selects all variants that excludes Sentence J 193, indicating a current sentence of which weight is being determined. As noted, because each variant corresponds to the sentence map identifying which sentence is present or missing in the variant, the sentence evaluation system 100 can complete selecting the variants excluding Sentence J 193 by scanning N sentence maps respectively corresponding to each of N variants 125.

Sentence J 193 in the sentence weight marked document D′ 109 represents the sentence 103 in the document D 101, and the sentence 103 and the Sentence J 193 are identical, except in visual representation. Sentence J 193 is noted with a sentence index, that is, J, as Sentence J 193 is used as a parameter to Weight function, to represent the predictive weight of Sentence J 193 as noted in Weight (J) 195. Then, the sentence evaluation system 100 proceeds with block 330.

Block 330 of FIG. 3 is performed for each variant selected in block 320 that does not include the current sentence, denoted as Sentence J 193. Block 330 for each variant excluding the current sentence can be performed concurrently for all variants selected from block 320, where computation resources are sufficient. Or the sentence evaluation system 100 may process each variant excluding the current sentence sequentially one by one.

In block 330, the sentence evaluation system 100 determines the difference between a confidence score of a prediction based on D 101 and a confidence score of a prediction based on a current variant I, denoted as (P(D)-P(I)). The difference in confidence scores, (P(D)-P(I)), presumably represents a reduced confidence caused by excluding m number of sentences including the current sentence. Thus, when N, the number of the variants 125, is large enough, and m, the number of sentences excluded from the document 101, is small enough, the sentence evaluation system 100 can measure the predictive contribution of individual sentence rather reliably, as noted above. Then, the sentence evaluation system 100 proceeds either with a next variant in sequential processing, or with block 340 in parallel processing in which all variants are processed concurrently.

In block 340, the sentence evaluation system 100 adds all differences in confidence scores, (P(D)-P(I)), from block 330 for all variants determined from block 320, and divides the sum of all differences in confidence scores (P(D)-P(I)) by number of all variants, that is, N. Then, the sentence evaluation system 100 proceeds with block 350.

In block 340, it should be noted that the number of variants from block 320 determined as excluding the current sentence, Sentence J, would be less than or equal to N, the number of all variants of the document D 101. It should also be noted that the difference in the confidence scores (P(D)-P(I)) reflect a collective effect of m excluded sentences, not only the current sentence, Sentence J. The result of block 340 indicates that how much probability, that is, the confidence score, has been reduced on average for the predictions made when Sentence J is not present from the input document 101, and conversely, an average predictive contribution made by Sentence J toward the predictions made by inputs including Sentence J.

In block 350, the sentence evaluation system 100 assigns the value resulting from block 340 as a predictive weight for the current sentence, Sentence J, denoted as Weight(J) 195. Then, the sentence evaluation system 100 proceeds either with a next sentence in sequential processing, or with block 360 in parallel processing in which all sentences are processed concurrently.

In block 360, the sentence evaluation system 100 produces the predictive weights of all sentences, in the document D 101, denoted as Weight(J) for J=[1, s], a closed interval from 1 and s, both 1 and s inclusive, where s indicates the number of all sentences in the document D 101. Then, the sentence evaluation system 100 proceeds with block 250 of FIG. 2.

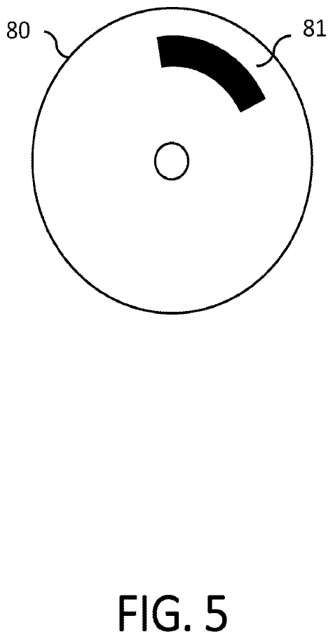

FIG. 5 shows an optical disc 80 as an example of a computer-readable medium comprising data.

The methods operative in the sentence evaluation system 100 may be implemented on a computer as a computer implemented method, as dedicated hardware, as firmware, or as a combination thereof. As also illustrated in FIG. 5, instructions for the computer, e.g., executable code, may be stored on a computer readable medium 80, e.g., in the form of a series 81 of machine-readable physical marks and/or as a series of elements having different electrical, e.g., magnetic, or optical properties or values. The medium 80 may be transitory or non-transitory. Examples of computer readable mediums include memory devices, optical storage devices, integrated circuits, servers, online software, etc.

Examples, embodiments or optional features, whether indicated as non-limiting or not, are not to be understood as limiting the present disclosure as claimed.

While the present disclosure has been illustrated and described in detail in the drawings and foregoing description, such illustration and description are to be considered illustrative or exemplary and not restrictive; the present disclosure is not limited to the disclosed embodiments.

For example, it is possible to operate the present disclosure in an embodiment wherein a computer implemented method includes: preparing the trained prediction model by selecting a prediction model based on performance of the prediction model, by training the prediction model with a labeled dataset in an application task compatible with an application task of the document repository, and by validating the performance of the prediction model to be greater than a confidence threshold by use of a test dataset amongst the labeled dataset that had not been used in the training, in combination with tuning the number of the variants of the document, denoted as N, and the predefined number of sentences to exclude from the document to make each of the variants, denoted as m, by use of a grid search approach with respect to a combination of N and m for all available combinations based on a validation dataset amongst a labeled dataset that had not been used in training the trained prediction model to thereby improve respective accuracies of the weight of the sentence for all the sentences in the document, as well as selecting, amongst the plurality of variants, each variant that does not include a current sentence; computing a difference between a confidence scores of a prediction based on a first variant of each variant from the selecting and the confidence score of the prediction based on the document; iterating the step of computing the difference for each variant from the selecting against the document; adding the respective differences from the computing; dividing a result from the adding by the number of the variants of the document from the making; and assigning a result from the dividing as a weight of the current sentence, and also combined with configuring the varying degrees of the visual effects for the document based on the application task, the varying degrees including two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of”' shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A computer implemented method comprising:
obtaining, by one or more processors, a document from a document repository, the document comprising a plurality of sentences;
generating, by the one or more processors, a plurality of variants of the document by excluding a predefined number of sentences from the document;
making, by the one or more processors, predictions based on the document and each of the variants, respectively, by use of a trained prediction model that provides a confidence score for each of the predictions, the confidence score indicating a probability of a prediction based on an input being correct;
determining, by the one or more processors, by use of the confidence scores respective to the predictions based on the document and each of the variants, a weight of a sentence for all sentences in the document, the weight of the sentence indicating an average contribution of the sentence to the confidence score of a prediction based on the document; and
presenting, by the one or more processors, via a user interface and a video output device, the document with varying degrees of visual effects determined based on respective weights of the sentences in the document, the varying degrees of visual effects are preconfigured for the document.

2. The computer implemented method of claim 1, further comprising:
preparing the trained prediction model by selecting a prediction model based on performance of the prediction model, by training the prediction model with a labeled dataset in an application task compatible with an application task of the document repository, and by validating the performance of the prediction model to be greater than a confidence threshold by use of a test dataset amongst the labeled dataset that had not been used in the training.

3. The computer implemented method of claim 1, further comprising:
tuning the number of the variants of the document, denoted as N, and the predefined number of sentences to exclude from the document to make each of the variants, denoted as m, by use of a grid search approach with respect to a combination of N and m for all available combinations based on a validation dataset amongst a labeled dataset that had not been used in training the trained prediction model to thereby improve respective accuracies of the weight of the sentence for all the sentences in the document.

4. The computer implemented method of claim 1, the determining comprising:
selecting, amongst the plurality of variants, each variant that does not include a current sentence;
computing a difference between a confidence scores of a prediction based on a first variant of each variant from the selecting and the confidence score of the prediction based on the document (330);
iterating the step of computing the difference for each variant from the selecting against the document;
adding the respective differences from the computing;
dividing a result from the adding by the number of the variants of the document from the making; and
assigning a result from the dividing as a weight of the current sentence.

5. The computer implemented method of claim 1, the determining comprising:
iterating, for all sentences in the document, the steps of:
selecting, amongst the plurality of variants, each variant that does not include a current sentence;
computing respective differences between respective confidence scores of predictions based on each variant from the selecting and the confidence score of the prediction based on the document;
adding the respective differences from the computing;
dividing a result from the adding by the number of the variants of the document from the making; and
assigning a result from the dividing as a weight of the current sentence.

6. The computer implemented method of claim 1, the determining comprising:
concurrently performing, for all sentences in the document, the steps of:
selecting, amongst the plurality of variants, each variant that does not include a current sentence;
computing respective differences between respective confidence scores of predictions based on each variant from the selecting and the confidence score of the prediction based on the document;
adding the respective differences from the computing;
dividing a result from the adding by the number of the variants of the document from the making; and
assigning a result from the dividing as a weight of the current sentence .

7. The computer implemented method of claim 1, the presenting comprising:
configuring the varying degrees of the visual effects for the document based on the application task, the varying degrees comprising two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

8. A system comprising a memory, one or more processors in communication with the memory, and program instructions executable by the one or more processors via the memory configured to:
obtain a document from a document repository, the document comprising a plurality of sentences;
generate a plurality of variants of the document by excluding a predefined number of sentences from the document;
make predictions based on the document and each of the variants, respectively, by use of a trained prediction model that provides a confidence score for each of the predictions, the confidence score indicating a probability of a prediction based on an input being correct;
determine, by use of the confidence scores respective to the predictions based on the document and each of the variants, a weight of a sentence for all sentences in the document, the weight of the sentence indicating an average contribution of the sentence to the confidence score of a prediction based on the document; and
present via a user interface and a video output device, the document with varying degrees of visual effects determined based on respective weights of the sentences in the document, the varying degrees of visual effects are preconfigured for the document.

9. The system of claim 8, wherein the program instructions executable by the one or more processors via the memory are further configured to:
prepare the trained prediction model by selecting a prediction model based on performance of the prediction model, by training the prediction model with a labeled dataset in an application task compatible with an application task of the document repository, and by validating the performance of the prediction model to be greater than a confidence threshold by use of a test dataset amongst the labeled dataset that had not been used for training.

10. The system of claim 8, wherein the program instructions executable by the one or more processors via the memory are further configured to:
tune the number of the variants of the document, denoted as N, and the predefined number of sentences to exclude from the document to make each of the variants, denoted as m, by use of a grid search approach with respect to a combination of N and m for all available combinations based on a validation dataset amongst a labeled dataset that had not been used in training the trained prediction model to thereby improve respective accuracies of the weight of the sentence for all the sentences in the document.

11. The system of claim 8, wherein the program instructions executable by the one or more processors via the memory are further configured to:
select, amongst the plurality of variants, each variant that does not include a current sentence;
compute a difference between a confidence scores of a prediction based on a first variant of each variant that has been previously selected and the confidence score of the prediction based on the document;
iterate the instruction to compute the difference for each variant that has been previously selected against the document;
add the respective differences that has been previously computed;
divide a result from adding the respective differences by the number of the variants of the document made; and
assign a result dividing a sum of the respective differences by the number of the variants of the document as a weight of the current sentence.

12. The system of claim 8, wherein the program instructions executable by the one or more processors via the memory are further configured to:
set values for the varying degrees of the visual effects for the document based on the application task, the varying degrees comprising two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.

13. A computer program product comprising data representing program instructions executable by one or more processors via a memory configured to:
obtain a document from a document repository, the document comprising a plurality of sentences;
generate a plurality of variants of the document by excluding a predefined number of sentences from the document;
make predictions based on the document and each of the variants, respectively, by use of a trained prediction model that provides a confidence score for each of the predictions, the confidence score indicating a probability of a prediction based on an input being correct;
determine, by use of the confidence scores respective to the predictions based on the document and each of the variants, a weight of a sentence for all sentences in the document, the weight of the sentence indicating an average contribution of the sentence to the confidence score of a prediction based on the document; and
present via a user interface and a video output device, the document with varying degrees of visual effects determined based on respective weights of the sentences in the document, the varying degrees of visual effects are preconfigured for the document.

14. The computer program product of claim 13, wherein the program instructions executable by the one or more processors via the memory are further configured to:
select, amongst the plurality of variants, each variant that does not include a current sentence;
compute a difference between a confidence scores of a prediction based on a first variant of each variant selected and the confidence score of the prediction based on the document;
iterate the instruction to compute the difference for each variant selected against the document;
add the respective differences computed;
divide a result from adding the respective differences by the number of the variants of the document made; and
assign a result dividing a sum of the respective differences by the number of the variants of the document as a weight of the current sentence.

15. The computer program product of claim 13, wherein the program instructions executable by the one or more processors via the memory are further configured to:
set values for the varying degrees of the visual effects for the document based on the application task, the varying degrees comprising two or more degrees of representation of the sentences in the document, the visual effects is selected from the group consisting of: a heat map of the sentences; and a turn on or off of the sentences, to manipulate a font size, a text effect, a font color, and a background color, and combinations thereof respective to the sentences according to the weight of each of the sentences in the document to thereby enhance visual impression of the sentences with more predictive weights.
